(19) United States
(12) Patent Application Publication
(10) Pub. No.: US 2016/0185087 A1
(43) Pub. Date: Jun. 30, 2016

(54) Films and Film Laser Converting

(71) Applicant: Avery Dennison Corporation, Glendale, CA (US)

(72) Inventors: Kourosh KIAN, Arcadia, CA (US); Rishikesh K. BHARADWAJ, Temple City, CA (US); Shanshan WANG, Mentor, OH (US); Wen-Li A. CHEN, Rochester, NY (US); Jessica ALESSANDRO, Lakewood, CA (US)

(21) Appl. No.: 14/948,262

(22) Filed: Nov. 21, 2015

Related U.S. Application Data
(60) Provisional application No. 62/098,010, filed on Dec. 30, 2014.

(51) Int. Cl. B32B 27/18; B32B 27/32; B32B 27/08

(52) U.S. Cl. CPC B32B 27/18; B32B 27/08; B32B 27/32; B32B 2519/00

(57) ABSTRACT

Various methods of laser cutting polyolefin films are described, and particularly using carbon dioxide lasers. Also described are modified polyolefin materials which can be subjected to laser cutting.

### CROSS REFERENCES TO RELATED APPLICATIONS

This application claims the benefit of U.S. Provisional Patent Application No. 62/098,010 filed Dec. 30, 2014, which is incorporated herein by reference in its entirety.

### FIELD

The present subject matter relates to laser cutting polyolefin films and label assemblies using carbon dioxide (CO₂) lasers.

### BACKGROUND

Adhesive labels and film assemblies are typically used by “converters” such as manufacturers, distributors, and/or retailers for packaging or preparing goods for commercial sale. Converters use processing equipment or “lines” to selectively cut the labels and/or film assemblies as desired and form packages for example for a wide array of commercial goods. Such converting lines may also perform additional operations with the labels and film assemblies such as printing for example.

Traditional converting lines typically include flexo-printing and mechanical die cutting equipment to selectively print and cut the labels and/or film assemblies. Mechanical die cutting is satisfactory in many regards, particularly for high volume converting lines.

Recently, digital converting lines that utilize one or more lasers for cutting labels and/or film assemblies have become increasingly popular. Digital converting lines are useful for low volume processing and enable greater flexibility in changing cutting parameters such as cutting depth and pattern(s), as compared to traditional mechanical die cutting. Laser converting of labels and film assemblies can be readily tailored to cut various shapes from the bulk label or film laminate(s). Changes to cutting parameters can be made easily via software that controls the laser cutter.

Most digital converting lines utilize CO₂ laser(s) that emit light typically having a wavelength of about 10.6 microns or within a range of about 10.2 to 10.60 microns. These emission wavelengths of CO₂ lasers are sometimes referred to as either “mid-infrared” and/or “long-infrared” wavelengths or wavelength ranges.

A difficulty encountered when using digital converting lines with CO₂ lasers for converting label and film laminate(s), is that many of the polymeric films used in such labels and film laminates are relatively transparent to light emitted from CO₂ lasers. An example of such a film is polyethylene. Due to the relatively high optical transmittance and thus low optical absorbance of polyethylene with respect to light emitted by CO₂ lasers, poor cutting performance by the laser is exhibited. Accordingly, a need exists for a method of enabling the use of CO₂ lasers for converting certain label and film laminates such as for example polyethylene materials.

A consequence of poor laser cutting is a slow cutting rate. For certain applications, a slow cutting rate may be acceptable if accompanied by increased process flexibility such as an ability to readily modify cutting shapes or patterns, for example. However, slow cutting rates are generally unacceptable particularly for high volume converting lines. In many applications, it is typically not possible to simply increase laser power to increase cutting rate. Many materials used in label and film laminates are susceptible to damage from higher laser power levels. And, undesired consequences may result from the use of higher laser power levels such as excessive heating of materials, undesirable cut face, and changes in material properties adjacent the cut face. Accordingly, a need exists for a method of increasing laser cutting rates without the attendant noted problems.

In many applications, it is desirable to “kiss cut” a label and liner assembly such that one or more films of the label are cut while not cutting or damaging the liner. Mechanical cutting assemblies have typically been used for performing such cutting operations. However, this requires precise control of the cutting process and mechanical components. Kiss cutting label and liner assemblies using lasers is known in the art, however damage to liners is a common problem. For example, when laser cutting certain grades of polyethylene films, it is necessary to use relatively high power levels for the laser. Such laser power levels typically severely damage the liner or some applications, cut through the liner. Accordingly, a need exists for a method of laser cutting and particularly laser kiss cutting of a label and liner assembly without damaging or cutting the liner.

### SUMMARY

The difficulties and drawbacks associated with previous approaches are addressed in the present subject matter as follows.

In one aspect, the present subject matter provides a method of laser cutting a polyolefin film using a CO₂ laser. The method comprises providing a polyolefin material. The method also comprises incorporating at least one agent in the polyolefin material. The agent is selected from the group consisting of at least one inorganic agent, at least one organic agent, and combinations thereof, to thereby form a modified polyolefin material having an increased optical absorbance. The method also comprises forming a film from the modified polyolefin material. And, the method additionally comprises using at least one CO₂ laser, laser cutting the film.

In another aspect, the present subject matter provides a multilayer film that can be cut using a CO₂ laser. The multilayer film comprises a core layer, and at least one skin layer. At least one of the core layer and the at least one skin layer includes a polyolefin and at least one agent at a concentration such that the multilayer film exhibits an increased optical absorbance to light having a wavelength of 10.6 microns or within a range of from 10.2 microns to 10.25 microns.

As will be realized, the subject matter described herein is capable of other and different embodiments and its several details are capable of modifications in various respects, all without departing from the claimed subject matter. Accordingly, the description is to be regarded as illustrative and not restrictive.

### DESCRIPTION OF THE DRAWINGS

FIG. 1 is a schematic cross sectional illustration of a typical label assembly in accordance with the present subject matter.

FIG. 2 is a schematic cross sectional illustration of one version of a film in accordance with the present subject matter.

FIG. 3 is a schematic cross sectional illustration of another version of a film in accordance with the present subject matter.

FIG. 4 is a schematic cross sectional illustration of another version of a film in accordance with the present subject matter.

FIG. 5 is a schematic cross sectional illustration of another version of a film in accordance with the present subject matter.

FIG. 6 is a schematic illustration of kiss cutting a label assembly using a laser in accordance with the present subject matter.

### DETAILED DESCRIPTION OF THE EMBODIMENTS

The present subject matter provides various methods of enabling laser cutting of films containing polyolefins such as polyethylene and similar materials, and particularly laser cutting using CO₂ lasers. By incorporating particular agents and at particular concentrations within the film, the optical absorbance of the film for wavelengths of (i) 10.6 μm and/or (ii) 10.2 μm to 10.25 μm can be significantly increased thereby enabling CO₂ laser cutting of the film. Stretching certain films to particular stretch ratios and at certain orientations can also significantly improve laser cutting of the film. Incorporation of the noted agents can be utilized in combination with strategic stretching of the film to produce a film that can be laser cut and in particular, cut using a CO₂ laser.

The present subject matter also provides various methods of kiss cutting label assemblies which include one or more films disposed on a liner. The films are typically polyolefin films as described herein and which include the noted agents to thereby increase the optical absorbance of the film for light having 10.6 μm and/or 10.2 μm wavelength. The film can also be stretched at particular stretch ratios and at certain orientations to promote laser cuttability of the film.

The present subject matter also provides various methods of increasing laser cutting speeds without increasing laser power, by (i) incorporating particular agents at particular concentrations within polymeric films such as polyolefin films which can be for example polyethylene and similar materials, and/or (ii) stretching the films to particular stretch ratios and at certain orientations. The methods are particularly useful for increasing laser cutting speeds for CO₂ lasers and/or for cutting polymeric materials such as polyethylene.

The present subject matter also provides various films which can be readily cut by lasers and particularly by CO₂ lasers. The various films can be monolayer films or can include multiple layers of polymeric materials. These and other aspects of the present subject matter are all described in greater detail herein.

### Optical Absorbancy

Before turning attention to various aspects of the present subject matter, it is instructive to review optical absorbancy of a material, measurement of such, and how optical absorbance is typically quantified.

In spectroscopy, the absorbance (also called optical density) of a material is a logarithmic ratio of the amount of radiation falling upon a material to the amount of radiation transmitted through the material. Absorbance measurements are often carried out in analytical chemistry. In physics, the term “spectral absorbance” is used interchangeably with “spectral absorptance” or “absorptivity.” A closely related term is “transmittance,” described below.

Absorbance at a certain wavelength of light (λ), denoted A_{λ}, is a quantitative measure expressed as Equation (1):

$${A}_{λ} = {log}_{10} \frac{{I}_{0}}{I} , \qquad ( 1 )$$

Thus, absorbance A_{λ}, is an unsigned logarithmic ratio between I_{O}, the radiation falling upon a material (the intensity of the radiation before it passes through the material or incident radiation) and I, the radiation transmitted through a material (the intensity of the radiation that has passed through the material or transmitted radiation). As such, absorbance is closely related to transmittance T:

A_{λ}=log₁₀(T⁻¹)=−log₁₀ T (2)

The term “absorption” refers to the physical process of absorbing light, while “absorbance” refers to the mathematical quantity.

Although absorbance is properly unitless, it is sometimes reported in “absorbance units”, or AU. However, many people, including scientific researchers, wrongly state the results from absorbance measurement experiments in terms of these arbitrary units.

Typically, absorbance of a material is measured using absorption spectroscopy. This involves directing a light through the material of interest and recording how much light and what wavelengths were transmitted to a detector. Using this information, the wavelengths that were absorbed can be determined. Referring to Equation (1), the transmitted intensity of the light source is I_{O}. The intensity of the light that passed through the sample is I. The absorbance of the material at a given wavelength can then be determined by Equation (1).

The absorption and scattering behavior of a transparent specimen or material will determine how much light will pass through and how objects will appear through the transparent material.

Total transmittance is the ratio of transmitted light to the incident light. It is influenced by the absorption and reflection properties of the specimen or material. The total transmitted light consists of directly transmitted light and diffused light. Depending on the angular distribution of the diffused portion, a transparent specimen will appear differently.

Visual perception can typically differentiate between two phenomena, wide angle and narrow angle scattering.

Wide angle scattering effects haze. Light is diffused in all directions causing a loss of contrast. ASTM D 1003 defines haze as that percentage of light which in passing through deviates from the incident beam greater than about 2.5 degrees on average.

Narrow angle scattering affects see-through quality and clarity. Light is diffused in a small angle range with high concentration. This effect describes how well very fine details can be seen through a specimen or material. The see-through quality or clarity is typically determined in an angle range smaller than 2.5 degrees. Measurement and analysis of haze and clarity quality promote a uniform and consistent product quality and help analyze influencing process parameters and material properties, e.g., cooling rate or compatibility of raw materials.

A haze meter provides an objective measurement of transparency of a film. In a haze meter, a light beam strikes the specimen and enters an integrating sphere. The sphere's interior surface is coated uniformly with a matte white material to allow diffusion. A detector in the sphere measures total transmittance and transmission haze. A ring sensor mounted at the exit port of the sphere detects narrow angle scattered light which in turn provides an indication of clarity. An example of a haze meter is an instrument commercially available from Oakland Instrument Corp. under the designation HAZEGARD PLUS.

### Agents

A wide array of agents can be incorporated in the polyolefin films in accordance with the present subject matter, and particularly polyethylene. A first group of agents are inorganic agents which can include for example (i) titanium dioxide, (ii) silica particulates, (iii) mica particulates coated with titanium dioxide, (iv) nanoclays and inorganic IR diffusers and (v) combinations thereof. These inorganic agents are useful for incorporating in opaque or white films.

Various grades and types of titanium dioxide particles (TiO₂) can be utilized which gives a white color to films that is more or less pronounced based on the concentration of the titanium dioxide particles. These particles are widely used for white polypropylene films. Different polypropylene (PP) films are made with various concentrations of TiO₂ from 0% to 20%. A concentration of only 5% TiO₂ transforms a practically non-laser cuttable film (using a 10.6 μm CO₂ laser) into a laser cuttable PP film. Higher concentrations of TiO₂ generally improve cuttability, i.e. less energy is needed to cut these films until no effect on laser cuttability generally occurs at concentrations above 25%. This “saturation” level depends on film thickness and orientation but also the type of produced film, for example whether the film is a blown film, a stenter film, or cavitated or not. Titanium dioxides are widely available in particle sizes under 1 μm, such as those for example available from DuPont under the designation TI-PURE.

Various grades and types of silica particulates can be utilized. For example, natural and/or synthetic silica particulates can be used. Silica filler master batch can be used, particularly for example a silica concentrate in polyethylene or polypropylene. Nonlimiting examples of commercially available silica which can be used include POLYBATCH IR 1515 and/or IR 2994 available from A. Schulman Inc. In many embodiments, silica is incorporated in polyolefin resin and particularly polyethylene and/or polypropylene, at a weight percentage within a range of from 7.5% to 15%.

As previously noted, the inorganic agent(s) can include mica particulates that are coated with titanium dioxide (TiO₂). The mica particulates are typically in flake form, however the present subject matter includes a variety of other shapes and configurations. The mica particulates, which are typically in flake form have a particle size range such that 95% of the particulates are within a size range of from 1 to 15 microns in length, as measured by light scattering. A typical average particle size is 4 microns. However, it will be appreciated that the present subject matter includes the use of any particle size appropriate for the end use application. The mica is coated with titanium dioxide. Various types and grades of titanium dioxide coated mica are commercially available and can be used in accordance with the present subject matter. A nonlimiting example of such coated mica is MAGNAPEARL 3000 from BASF. In many embodiments, the titanium dioxide coated mica is incorporated within the polyolefin at a weight concentration within a range of from 2% to 20%, more particularly 2.5% to 10%, and 5% being useful for certain embodiments.

As noted, the inorganic agent(s) can also include nanoclays and inorganic IR diffusers. Representative nonlimiting examples of inorganic IR diffusers include those commercially available from Colortech under the designation COLORTECH 100LT7969, COLORTECH 100LM4529, and COLORTECH 100LM4559.

A second group of agents are organic agents which can include for example (i) polymers containing at least one vinyl acetate group, (ii) polymers containing at least one vinyl alcohol group, (iii) polyethylene terephthalate glycol (PETG), (iv) certain acrylics such as poly(methyl methacrylate) (PMMA), (v) nylon, and (vi) combinations thereof. These organic agents are useful for incorporating in clear films. In certain applications these agents are useful for incorporating in opaque and particularly white films.

In many embodiments of the present subject matter, the organic agent(s) can be vinyl acetate and/or agents that contain vinyl acetate groups such as for example ethylene vinyl acetate and/or ethylene vinyl acetate copolymer. In particular versions of the subject matter in which a copolymer of ethylene and vinyl acetate is used, the copolymer has a vinyl acetate content within a range of from 2.5% to 55%. A wide array of commercial sources exist for ethylene vinyl acetate and/or ethylene vinyl acetate copolymer. For example, ethylene vinyl acetate copolymer is commercially available under the designation ATEVA from Celanese Corporation. Suitable grades include ATEVA 1821A which includes 18% vinyl acetate. Another commercial source of ethylene vinyl acetate copolymer is under the designation EVATANE from ARKEMA. Suitable grades include EVATANE 28-03 which includes 28% vinyl acetate. A wide array of grades of ethylene vinyl alcohol and/or components that include ethylene vinyl alcohol can be utilized as the organic agent(s). In certain versions, the weight percentage of vinyl alcohol in the EVOH is about 62.5%. In many embodiments, the organic agent includes modified polyolefin copolymer resin which is the reaction product of at least an olefin monomer and at least an ester group containing monomer such as ethylene vinyl acetate copolymer, ethylene acrylic acid copolymer, ethylene acrylate copolymers, ethylene methyl acrylate copolymers, and ethylene butyl acrylate copolymer. The organic agent can also be in the form of polyethylene terephthalate glycol (PETG) and/or derivatives thereof. Certain acrylics can be used for the organic agent such as for example poly(methyl methacrylate) (PMMA). The organic agent can also be in the form of amorphous nylon or aliphatic polyamides. In certain embodiments in which the organic agent is nylon, the nylon can be an amorphous nylon or a crystalline nylon. For versions in which the nylon is a crystalline nylon, nylon-MXD6 can be used which include a wide range of polyamides produced from m-xylenediame (MXDA). Nylon-MXD6 is a crystalline polyamide produced by condensation of MXDA with adipic acid. Nylon-MXD6 is an aliphatic polyamide containing an aromatic ring in its main chain, and thus is distinguishable from nylon 6 and nylon 6,6. Additional details of one or more of these organic agents are described in conjunction with films herein.

The amounts of the organic agent(s) are selected such that the total amount of the organic agent in the polyolefin material is within a weight percentage range of from 2.5% to 55%, and particularly from 15% to 50%. In certain embodiments, if the organic agent(s) include vinyl acetate and/or vinyl acetate containing agents, the amounts of the agents are selected such that the total amount of the vinyl acetate in the polyolefin material is within a weight percentage of from 2.5% to 15%, more particularly from 7.5% to 15%, and in certain versions about 10%.

A third group of organic agents that are used are acrylic, polystyrene (PS), polylactic acid (PLA), polycarbonate (PC) and thermoplastic polyurethane (TPU) commercially available under the designation KRYSTAGRAM from Huntsman International, LLC. Both PLA and PS are incompatible with polyethylene (PE). Typically PLA and PS are not blended with PE in making films due to the poor mixing and poor mechanical properties resulting from the incompatible materials. However, in certain embodiments of the present subject matter, these materials. i.e., PLA and PS, can be used as well as acrylic and polycarbonate by blending them as single layer in a multilayer film. Generally, a tie layer is needed for both PLA and PS.

It is also contemplated that combinations of one or more of the noted inorganic agents and one or more of the noted organic agents can be used.

The various agent(s) are incorporated in the film material prior to formation of the film as this practice promotes a relatively uniform distribution of the agent(s) within the film rather than a coating on the film or non-uniform distribution of the agent(s) within the film. A wide array of techniques can be used to incorporate the one or more agents in the film material. In many embodiments, the agent(s) is incorporated in the film material while the film material is in a flowable or liquid state. Conventional mixing and/or blending operations can be used to uniformly disperse the one or more agent(s) in the film material. After forming the modified polyolefin film material containing the noted agent(s) conventional techniques can be used to form films.

In certain embodiments, the one or more agent(s) are combined with one or more polyolefins to form a modified polyolefin such that the clarity of a film of the modified polyolefin is comparable to a corresponding film of the polyolefin free of agent(s). The term “comparable” as used herein is with regard to the optical clarity of a film of modified polyolefin to that of a film of the polyolefin. Specifically, that term refers to the optical clarity of the modified polyolefin film being within 90%, in certain embodiments within 95%, and in particular embodiments within 100%, of the optical clarity of the polyolefin film free of the agent(s). The term “optical clarity” as used herein refers to the clarity or transparency of a film with regard to visible light. Optical clarity can be measured by clarity meters available in the art and is generally defined by ASTM D1746.

### Films

As noted, the present subject matter is directed to polyolefin films that can be subjected to laser cutting and effectively cut, shaped and/or patterned by the laser. Polyolefins comprise homopolymers or copolymers of olefins that are aliphatic hydrocarbons having one or more carbon-to-carbon double bonds. Olefins include alkenes that comprise 1-alkenes, also known as alpha-olefins, such as 1-butene and internal alkenes having the carbon-to-carbon double bond on nonterminal carbon atoms of the carbon chain, such as 2-butene, cyclic olefins having one or more carbon-to-carbon double bonds, such as cyclohexene and norbornadiene, and cyclic polyenes, which are noncyclic aliphatic hydrocarbons having two or more carbon-to-carbon double bonds, such as 1,4-butadiene and isoprene. Polyolefins comprise alkene homopolymers from a single alkene monomer, such as a polypropylene homopolymer, alkene copolymers from at least one alkene monomer and one or more additional olefin monomers where the first listed alkene is the major constituent of the copolymer, such as a propylene-ethylene copolymer and a propylene-ethylene-butadiene copolymer, cyclic olefin homopolymers from a single cyclic olefin monomer, and cyclic olefin copolymers from at least one cyclic olefin monomer and one or more additional olefin monomers wherein the first listed cyclic olefin is the major constituent of the copolymer, and mixtures of any of the foregoing olefin polymers.

In one embodiment, the film is a blend of one or more polymers or polymeric components. For example, the film may be in the form of a monolayer film comprising a blend of one or more polyolefins and ethylene vinyl acetate copolymer (EVA), in a blend ratio of from about 60% to about 80% polyolefin(s) and from about 20% to about 40% EVA, with particular ratios of 80/20, 70/30, and 60/40, respectively, being useful.

In one embodiment, the film is a multilayer film comprising a core layer and at least one skin layer. The skin layer can be a printable skin layer. In one embodiment, the multilayer film comprises a core and two skin layers, wherein in at least one skin layer is printable. In another embodiment, the multilayer film is a five layer film including two skin layers, two tie layers, and a core layer. Each tie layer is positioned between a skin layer and the core layer. In many applications the multilayer films such as the noted three or five layer films can utilize symmetric arrangement in which the composition of the skin layers is the same, and/or the composition of the tie layers is the same.

In one embodiment, the film comprises a halogen-free, multilayer film comprising (a) a core layer comprising a copolymer of ethylene or propylene with an alpha olefin and the core having an upper and lower surface, (b) one or more skin layer(s) on the upper surface of the core layer, wherein the skin layer comprises a polyolefin or polyolefin blend and (c) one or more printable layer(s) on the lower surface of the core layer.

The print skin layer comprises at least one polyethylene (PE) and at least one polypropylene (PP). The polyethylene comprises a polyethylene having a density ranging up to about 0.97 g/cm³, or from about 0.86 or 0.87 to about 0.94 g/cm³. The polyethylene can comprise a very low density polyethylene (VLDPE), a low density polyethylene (LDPE), a linear low density polyethylene (LLDPE), a medium density polyethylene (MDPE), a high density polyethylene (HDPE), or a mixture of any of the foregoing polyethylenes. The mixture of polyethylenes can comprise two or more polyethylenes of the same type such as for example a mixture of two linear low density polyethylenes or can comprise two or more polyethylenes taken from two or more different types such as for example a mixture of a LLDPE and a MDPE. A VLDPE generally has a density ranging from 0.88 to 0.915 g/cm³ and can comprise a polyethylene copolymer prepared via metallocene or Ziegler-Natta (Z-N) catalysis from ethylene and an alpha-olefin comonomer having 3 to 20 carbon atoms where the comonomer content is above 4 to 25 mole %. In general the metallocene catalyst gives more uniform branching and more homogeneity in the polymer compared to the Z-N catalyst. A LDPE generally has a density ranging from 0.86 or 0.87 to 0.935 and can comprise a polyethylene homopolymer, a polyethylene copolymer from ethylene and one or more C₃-C₂₀ alpha-olefin comonomers, or a mixture of any of the foregoing polymers where the LDPE is prepared under high pressure using free radical catalysis. A LDPE has short chain and long chain branching. A LLDPE generally has a density ranging from 0.86 or 0.87 to 0.93 g/cm³ and can comprise a polyethylene copolymer prepared from ethylene and one or more C₃-C₂₀ alpha-olefin comonomers using Z-N or metallocene catalysis where the comonomer content is 2.5 to 3.5 mole %. A LLDPE has short chain branching. A MDPE generally has a density ranging from 0.925 to 0.94 g/cm³ and can comprise a polyethylene copolymer prepared from ethylene and one or more C₃-C₂₀ alpha-olefin comonomers using Z-N or metallocene catalysis where the comonomer content is 1-2 mole %. The print skin layer (A) in an embodiment of the present subject matter comprises a low viscosity LLDPE from Ziegler-Natta catalysis and a LLDPE from metallocene catalysis. The low viscosity LLDPE from Z-N catalysis can have a melt index by ASTM Method D1238 in g/10 minutes at 190° C./2.16 kg of 3-40, 5-30, or 7-20. The polyethylenes described hereinabove are available from resin suppliers such as Dow Chemical Co. and Exxon-Mobil Chemical Co. Specific examples of useful Z-N polyethylenes include Dowlex 2517 from Dow; L2101 or L8148 (melt index of 0.9) and Marflex 7105 DL (melt index of 0.5) from Chevron Phillips from Huntsman. Dowlex 2517 has a density of 0.917 g/cc and melt index of 25 g/10 min, and L2101 has a melt index of 24 g/10 min. Examples of metallocene catalyzed LLDPEs include Exxon-Mobil EXACT 4049, (density 0.873 g/cc and a melt index of 4.5 g/10 min); and Dow AFFINITY 8200G (density of 0.870 g/cc) and AFFINITY KC8852 (melt index of 3.0). An example of HDPE which is commercially available is HDPE DMDA 8904 NT7 available from Dow Chemical Company.

The polypropylene can comprise a polypropylene homopolymer, a polypropylene copolymer, or a mixture of any of the foregoing polymers. The polypropylene can be prepared using a Z-N or metallocene catalyst. In certain versions, the polypropylene is homo polypropylene. An example of such is P4G3Z-050F commercially available from Flint Hills Resources.

In another embodiment, the polypropylene may be a propylene copolymer, and the propylene copolymers comprise polymers of propylene and up to about 40% by weight of at least one alpha-olefin selected from ethylene and alpha-olefins containing from 4 to about 12, or from 4 to about 8 carbon atoms. Examples of useful alpha-olefins include ethylene, 1-butene, 1-pentene, 4-methyl-1-pentene, 1-hexene, 1-heptene, and 1-octene. In one embodiment, the polymers of propylene which are utilized in the present subject matter comprise polymers of propylene with ethylene, 1-butene, hexene or 1-octene. The propylene alpha-olefin polymers useful in the present subject matter include random as well as block copolymers although the random copolymers generally are particularly useful. In one embodiment, the films are free of impact copolymers. Blends of two or more propylene copolymers as well as blends of the propylene copolymers with propylene homopolymers can be utilized.

In one embodiment, the propylene copolymers are propylene-ethylene copolymers with ethylenic contents from about 0.2% to about 10% by weight. In another embodiment, the ethylene content is from about 3% to about 10% by weight, or from about 3% to about 6% by weight. With regard to the propylene-1-butene copolymers, butene contents of up to about 15% by weight are useful. In one embodiment, the 1-butene content generally may range from about 3% by weight up to about 15% by weight, and in other embodiments, the range may be from about 5% to about 15% by weight. Propylene-1-hexene copolymers may contain up to about 35% by weight 1-hexene. In one embodiment, the amount of 1-hexene is up to about 25% by weight. Propylene-1-octene copolymers useful in the present subject matter may contain up to about 40% by weight of 1-octene. More often, the propylene-1-octene copolymers will contain up to about 20% by weight of 1-octene.

The propylene copolymers useful in preparing the film facestock of the present subject matter may be prepared by techniques well known to those skilled in the art, and many such copolymers are available commercially. For example, the copolymers useful in the present subject matter may be obtained by copolymerization of propylene with an alpha-olefin such as ethylene or 1-butene using single-site metallocene catalysts.

In one embodiment, the outer or print skin comprises on a weight basis, from about 60% to about 90% of at least one polyethylene and from about 10% to about 40% of at least one polypropylene. In another embodiment, the print skin layer comprises from about 70% to about 90% of at least one polyethylene and from about 10 to about 30% of at least one polypropylene. In another embodiment the print skin layer comprises from about 37-53% of a low viscosity ZN LLDPE, about 23-37% of a metallocene LLDPE and about 10-40% of a propylene homopolymer.

In another embodiment the other or skin layer comprises of about 50% to 100% of high density polyethylene HDPE and about 10% to 50% of LLDPE. It will be understood that in certain embodiments, HDPE is used as the sole material in the skin layer in both three layer formulations with EVA in the core and in five layer formulations where the layer of EVA is surrounded for instance by two layers of PP or HPP.

In a particular embodiment the multilayer film is three layer symmetric film with ethylene vinyl acetate copolymer (EVA) in the core and 100% high density polyethylene (HDPE) in each skin layer. The films are made with each material in a separate layer defined by their thickness ratios over the total film thickness. These formulations are made with about EVA layer ratios of about 50% to about 80% and HDPE ratios of about 10% to about 30%, with particular ratios of 15/70/15, 20/60/20, 22.5/65/22.5 and 25/50/25. All raw materials are commercially available for instance HDPE DMDA 8904 NT7 available from Dow Chemical Company.

In one embodiment, the multilayer film is a five layer symmetric film with one or more ethylene vinyl alcohol (EVOH) copolymer(s) in the core. A wide array of EVOH copolymers can be used, but a representative example of such material is commercially available under the designation EVALCA G176B from Kuraray America, Inc., having a vinyl alcohol content of 52% (mole percent). This five layer symmetric film can include two skin layers each comprising HDPE, and in certain versions exclusively HDPE, i.e., 100% HDPE in each skin layer. Disposed between the core layer and each skin layer is a tie or intermediate layer. Although a wide array of tie layer(s) can be used, a representative example is a layer that includes a random terpolymer of ethylene, ethyl acrylate, and maleic anhydride, such as LOTADER 4700 which is commercially available from Arkema, Inc. Such terpolymers typically include about 30% ethyl acrylate and about 1.5% maleic anhydride. However, it will be appreciated that the present subject matter includes a wide array of other terpolymers, polymers, and/or polymeric components for use in one or more tie layers. For example, in certain embodiments the tie layer comprises one or more compounds selected from the group consisting of a copolymer or terpolymer of olefin and other polar groups such as vinyl acetate, methyl acrylate, ethyl acrylate, butyl acrylate, maleic anhydride.

In another embodiment, the multilayer film is a five layer symmetric film with one or more poly(methyl methacrylate) (PMMA) polymer(s) in the core. Nonlimiting examples of PMMA which can be used include PLEXIGLAS VM100 which is commercially available from Arkema, Inc. In certain versions, the core comprises exclusively PMMA. The multilayer film also includes two skin layers, each of which comprises HDPE. In certain versions, each skin layer comprises exclusively HDPE. The multilayer film also includes a tie layer disposed between each skin layer and the core layer. The tie layer comprises a terpolymer of ethylene, ethyl acrylate and maleic anhydride. Nonlimiting examples of tie layer material can include the noted LOTADER 4700. In certain versions, each tie layer comprises exclusively LOTADER 4700.

In another embodiment, the multilayer film is a five layer symmetric film h one or more polyethylene terephthalate glycol (PTEG) copolymer(s) in the core. Nonlimiting examples of PETG copolymers which can be used include CADENCE COPOLYESTER GS2 which is commercially available from Eastman Chemical Company. In certain versions, the core comprises exclusively PETG copolymer. The multilayer film also includes two skin layers, each of which comprises HDPE. In certain versions, each skin layer comprises exclusively HDPE. The multilayer film also includes a tie layer disposed between each skin layer and the core layer. The tie layer can include the noted LOTADER 4700. In certain versions, each tie layer comprises exclusively LOTADER 4700.

In another embodiment, the multilayer film is a five layer symmetric film with one or more nylon MXD6 copolymer(s) in the core. Nonlimiting examples of nylon copolymers which can be used include POLYAMIDE MXD 6 which is commercially available from Mitsubishi Gas Chemical Co. In certain versions, the core comprises exclusively nylon MXD6 copolymer. The multilayer film also includes two skin layers, each of which comprises HDPE. In certain versions, each skin layer comprises exclusively HDPE. The multilayer film also includes a tie layer disposed between each skin layer and the core layer. The tie layer can include the noted LOTADER 4700. In certain versions, each tie layer comprises exclusively LOTADER 4700.

In particular embodiments of five layer films, particular layer thicknesses are used. The following layer thickness percentages are based upon the total thickness of the five layer film. The thickness of each of the outermost skin layers can be the same or different and typically are each within a range of from 5% to 45%, more particularly from 10% to 40%, and in certain versions from 17.5% to 35%. The thickness of a core layer is typically from 5% to 75%, more particularly from 10% to 70%, and in certain versions 15% to 50%. The thickness of each intermediate layer, i.e., the layer(s) between the core and skin layers, can be the same or different and typically are within a range of from 2% to 15%, more particularly from 5% to 10%, and in certain versions 7.5%.

In many embodiments of the present subject matter, the films are laser cuttable, i.e., can be readily cut using a CO₂ laser, exhibit excellent film clarity, and exhibit high stiffness in both machine and cross directions.

Various descriptions of films being laser cuttable are noted herein. A film is said to exhibit good or favorable laser cuttability by observation of one or more of the following. After laser cutting, a sharp face along the film edge is formed free or substantially free of film remnants and adhesive (if present). After laser cutting, low “recast” of film material is present along the edges or faces of the film which were exposed to the laser. For straight or linear cuts, the resulting cut face is relatively straight and not jagged or irregular.

Excellent film clarity as described herein occurs at a clarity level of at least 80%, more particularly greater than 90%, and in certain embodiments greater than 95%. Corresponding excellent haze values occur at a haze level less than 20%, more particularly less than 10%, and in certain embodiments less than 5%. In certain embodiments of the present subject matter, the clarity of a polyolefin film containing one or more agents as described herein is comparable to the clarity of that film free of such agents.

High stiffness of the films as described herein is exhibited by a Young's modulus within a range of from 7 KPSI to 550 KPSI in a machine direction. In certain embodiments, the films exhibit a Young's modulus of at least 150 KPSI in the machine direction. Young's modulus of films is measured according to ASTM D882.

### Stretching and Orientation of Films

In many embodiments of the present subject matter, ability to laser cut polyolefin films can be improved by stretching the films prior to laser cutting. Specifically, stretching to particular stretch ratios and/or stretching in a direction transverse or at least different than the direction of laser cutting leads to less energy requirements for laser cutting. For laser cutting in a cross direction (CD), films are stretched in a machine direction (MD) to produce an MDO film. The MDO film can then be laser cut in a transverse direction, i.e., CD, using relatively low power levels as compared to a non-stretched film. Stretching of polymeric films and equipment used for such processing are described in one or more of U.S. Pat. No. 6,835,462; US 2009/0297820; U.S. Pat. No. 5,709,937; U.S. Pat. No. 5,451,283, and US 2013/0192744.

In certain embodiments of the present subject matter, films that have been stretched to a stretch ratio within a range of from 3:1 to 15:1, and more particularly from 5:1 to 10:1, exhibit improved laser cuttability as compared to films of the same composition but which are not stretched.

The polyolefin films of the present subject matter can be produced using a variety of methods. Representative and nonlimiting examples of such methods include casting to form cast films, stentering to form stenter films, orienting to form oriented films, or avoiding orienting in the film production to form a non-oriented film.

Additional details and aspects of various monolayer films and multilayer films in accordance with the present subject matter are set forth in Tables 1 and 2 as follows.

TABLE 1
Representative Films of the Present Subject Matter

| | Layer 1 and 5 | | | | |
|---|---|---|---|---|---|
| | (Skin) | Layer 2 and 4 | Layer 3 (Core) | Layer Ratio | Gauge |
| Film Structure | Formulation | (Tie) Formulation | Formulation | (1/2/3/4/5) % | (mil) |
| Monolayer film | PP/EVA blend | N/A | N/A | | 2.5 |
| | (blend ratio 80% | | | | |
| | PP + 20% EVA) | | | | |
| Monolayer film | PP/EVA blend | N/A | N/A | | 2.5 |
| | (blend ratio 70% | | | | |
| | PP + 30% EVA) | | | | |
| Monolayer film | PP/EVA blend | N/A | N/A | | 2.5 |
| | (blend ratio 65% | | | | |
| | PP + 35% EVA) | | | | |
| Five layer symmetric | 100% HDPE | 100% Lotader | 100% EVOH | 35/7.5/15/7.5/35 | 3.5 |
| film with EVOH in the | | 4700 (tie resin) | (48% Et) | 25/7.5/35/7.5/25 | 3.5 |
| core | | | | 17.5/7.5/50/7.5/17.5 | 3.5 |
| Five layer symmetric | 100% HDPE | 100% Lotader | 100% PMMA | 35/7.5/15/7.5/35 | 3.5 |
| film with PMMA in the | | 4700 (tie resin) | | 25/7.5/35/7.5/25 | 3.5 |
| core | | | | 17.5/7.5/50/7.5/17.5 | 3.5 |
| Five layer symmetric | 100% HDPE | 100% Lotader | 100% PETG | 35/7.5/15/7.5/35 | 3.5 |
| film with PETG in the | | 4700 (tie resin) | | 25/7.5/35/7.5/25 | 3.5 |
| core | | | | 17.5/7.5/50/7.5/17.5 | 3.5 |
| Five layer symmetric | 100% HDPE | 100% Lotader | 100% Nylon | 35/7.5/15/7.5/35 | 3.5 |
| film with amorphous | | 4700 (tie resin) | MXD 6 | 25/7.5/35/7.5/25 | 3.5 |
| nylon MXD 6 nylon 6 | | | | 17.5/7.5/50/7.5/17.5 | 3.5 |
| in the core | | | | | |

The layer ratios in Table 1 are layer thickness ratios expressed in percentages of the thickness of each layer in the particular multilayer film, based upon the total thickness of the multilayer film.

TABLE 2
Details of Certain Commercially Available Materials

| | | | | Density | |
|---|---|---|---|---|---|
| General | Chemical | Product Name | Supplier | (g/cm³) | Additional Notes |
| EVOH | Ethylene Vinyl Alcohol | Evalca G176B | Kuraray America | 1.12 | Vinyl alcohol |
| | Copolymer | | Inc. | | content 52% mole |
| PMMA | Poly(methyl methacrylate) | Plexiglas VM100 | ARKEMA Inc. | 1.18 | |
| PETG | Polyethylene Terephthalate | Cadence ™ | Eastman Chemical | 1.28 | |
| | Glycol Copolymer | Copolyester GS2 | Company | | |
| Nylon | Nylon 6 | Polyamid MXD 6 | Mitsubishi Gas | 1.15 | |
| | | | Chemical Co., | | |
| | | | Indiana | | |
| Tie resin | A random terpolymer of | Lotader 4700 | Arkema Inc. | 0.94 | [EA] = 30% weight, |
| | Ethylene (E), Ethyl Acrylate | | | | [MAH] = 1.5% weight |
| | (EA) and Maleic Anhydride | | | | |
| | (MAH) | | | | |
| HDPE | High density polyethylene | Dow ™ HDPE | Dow Chemical | 0.95 | |
| | | DMDA 8904 NT7 | Company | | |
| HPP | Homo polypropylene | P4G3Z-050F | Flint Hills | 0.90 | |
| | | | Resources | | |
| EVA-18 | Ethylene vinyl acetate | Ateva 1821 | Celanese | 0.94 | Vinyl acetate 18% |
| | copolymer | | | | weight |

Table 2 provides additional details as to particular materials which are commercially available and which can be used as one or more organic agent(s) for combining with polyolefin material(s), and/or for use and incorporation with films as described herein.

The various films can further comprise one or more additional thermoplastic polymers. The one or more additional thermoplastic polymers can comprise polyolefins other than polyethylenes and polypropylenes, alkene-unsaturated carboxylic acid or unsaturated carboxylic acid derivative copolymers, styrene-based polymers or copolymers, polyurethanes, poly(vinyl chloride)s, polycarbonates, polyamides, fluoroplastics, poly(meth)acrylates, polyacrylonitriles, polyesters, or a mixture of any of the foregoing polymers. In certain versions, the films or one or more layer(s) of the multilayer films includes one or more ethylene vinyl acetate (EVA) copolymer(s). An example of such a copolymer which is commercially available is ATEVA 1821 available from Celanese.

The various layers can further comprise one or more additives as described in U.S. Pat. No. 6,821,592. The one or more additives can comprise a nucleating agent, an antiblock agent, a processing aid, a slip agent, an antistatic agent, a pigment, a cavitating agent, an inorganic filler, an antioxidant, or a mixture of any of the foregoing additives.

The films typically have a total thickness of from about 25 microns to about 300 microns or more. These thickness values include one or more adhesive layers that may be disposed on the film or outer layer of the film. In certain embodiments, the total thickness of the film and adhesive is from 50 microns to 150 microns. In particular embodiments, the films (free of adhesive) exhibit a thickness of from 25 microns to 90 microns.

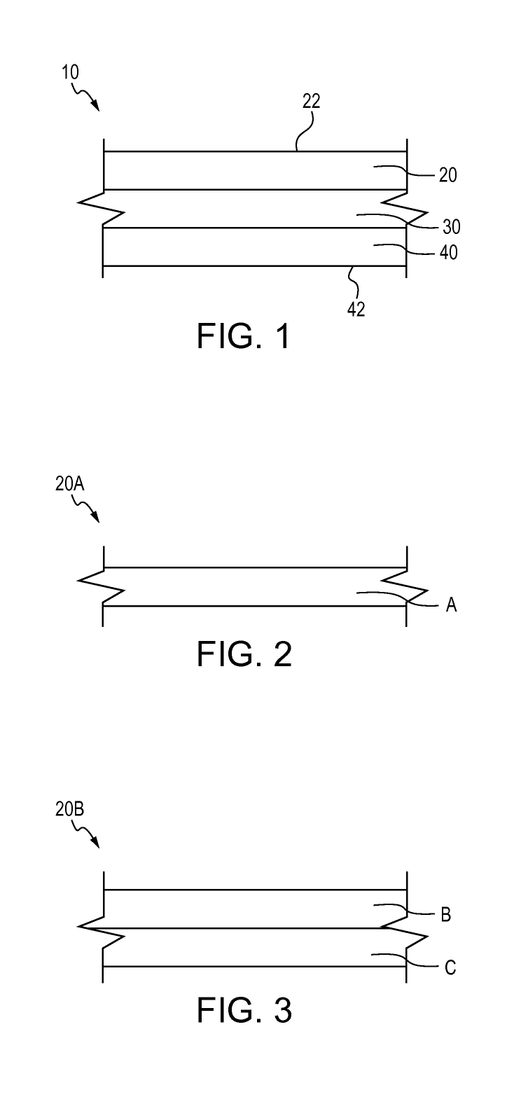

FIG. 1 is a schematic cross sectional illustration of a label assembly 10 comprising one or more polymeric films 20 and more particularly at least one polyolefin film, one or more region(s) or layer(s) of adhesive 30, and a liner 40 or liner assembly. The adhesive 30 is disposed between the film(s) 20 and the liner 40. The film(s) 20 can include any of the films and/or materials noted herein and may in certain embodiments be in the form of multiple polymeric films. The adhesive 30 can be any adhesive typically used in label constructions such as for example one or more pressure sensitive adhesives. The liner 40 can be one or more paper liners, one or more polymeric liners, or a combination of paper and polymeric materials. In certain embodiments the liner is polyethylene terephthalate (PET). The label assembly 10 defines an outer film face 22 and an oppositely directed liner underside 42.

As noted, the film 20 can be in the form of a single layer, i.e., a monolayer, or as a collection or plurality of layers, i.e., a multilayer film. FIG. 2 schematically depicts a monolayer film 20A. The film 20A can comprise one or more polymeric components combined with one or more agents as described herein to form layer A. The agents can include inorganic agents as described herein, and/or organic agents as described herein. The various agent(s) are typically dispersed and particularly, uniformly dispersed within and/or throughout the film 20A. In one version, layer A includes one or more inorganic agent(s) dispersed throughout a matrix of polymeric components which include at least one polyolefin. In another version, layer A includes one or more organic agent(s) blended with polyethylene. In certain embodiments, the film 20A may be free of agents if the film is utilized in an assembly having at least one region that has been rendered laser cuttable as described herein.

FIG. 3 schematically illustrates a two layer film 20B. The two layer film 20B can include layers which are compositionally the same or different from each other. In one version, one layer such as layer B comprises one or more polyolefin(s) free of any agents, and another layer such as layer C comprises one or more inorganic agent(s) dispersed within a polymeric matrix that includes at least one polyolefin.

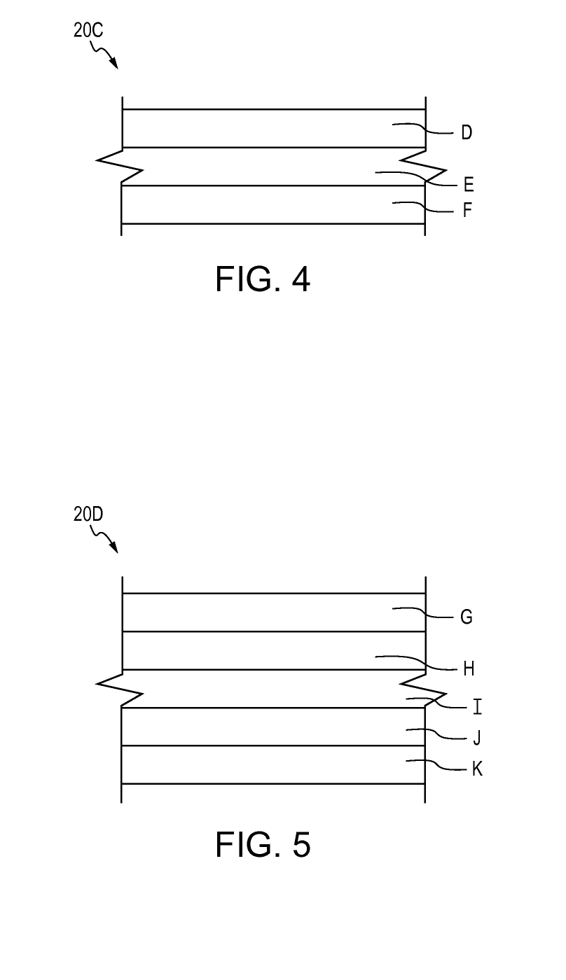

FIG. 4 schematically illustrates a three layer film 20C. The three layer film 20C can include layers that are compositionally the same or different from each other. In certain versions, the layers D and F are compositionally the same. In certain versions, one or more agents are incorporated in one or more of layers D, E, and F. For example, a particular version of the three layer film 20C includes each of layers D and F including one or more polyolefins and each layer D and F being free of agent(s), and layer E including one or more organic agent(s) combined with one or more polymeric components.

FIG. 5 schematically depicts a five layer film 20D. The five layer film includes skin layers G and K, a core layer I, and tie layers H and J. As shown, each tie layer H, J, is disposed between a corresponding skin layer G, K, and the core layer I. Each of the layers G, H, I, J, and K can be as described herein.

### Methods

The present subject matter provides various methods involving laser cutting. In one embodiment, the present subject matter provides a method of laser cutting a polyolefin film using a CO₂ laser. The method comprises providing a polyolefin material. The method also comprises incorporating at least one agent in the polyolefin material. The agent is selected from the group consisting of at least one inorganic agent, at least one organic agent, and combinations thereof, to thereby form a modified polyolefin material having an increased optical absorbance. As previously described, typically the polyolefin material is in a flowable or liquid state during the noted incorporation of the agent(s). The method also comprises forming a film from the modified polyolefin material. And, the method further comprises using at least one CO₂ laser, laser cutting the film. The film can be a monolayer or a multilayer film. The agent(s) can be incorporated in one or more layers of a multilayer film.

In another embodiment, the present subject matter provides a method of increasing laser cutting speed of a polyolefin film using a CO₂ laser, without increasing laser output or duty cycle. The method comprises providing a polyolefin material. The method also comprises incorporating at least one agent in the polyolefin material. The agent is selected from the group consisting of at least one inorganic agent, at least one organic agent, and combinations thereof, to thereby form a modified polyolefin material having an increased optical absorbance. The method additionally comprises forming a film from the modified polyolefin material, and using at least one CO₂ laser, laser cutting the film.

The laser cutting may be targeted to cut entirely through the thickness of the film or laminate. In certain embodiments, the laser cutting may only partially cut through a thickness of the film. For cutting films as described herein, typical linear speeds of laser cutting depend upon the laser power, the material to cut and the label shape being cut. Typical linear web speeds can be as high as up to 500 mm/second (30 m/min), or in certain applications faster such as for example up to about 1,000 mm/second (60 m/min).

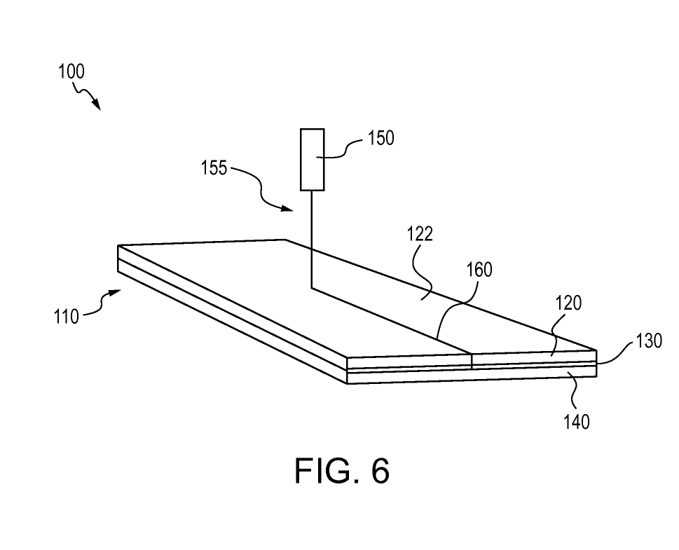

As noted, in many applications it is desired to kiss cut one or more film layers and optionally one or more adhesive layers, while not damaging or cutting an underlying liner layer. FIG. 6 schematically depicts a method 100 for kiss cutting a label assembly 110 including one or more film layers 120, a liner or liner assembly 140, and adhesive 130 disposed therebetween. The label assembly defines a film face 122. The method involves providing a CO₂ laser 150 as described herein. The laser is operated to emit a laser beam 155 directed at the film face 122. In accordance with an embodiment of the present subject matter, the label assembly 110 is kiss cut so that the film layer 120 and optionally the adhesive 130 are cut by the laser beam 155 to thereby form a cut line 160, while avoiding damage or cutting of the liner 140. As will be appreciated, the cut line 160 can be formed by moving the laser 150, moving the label assembly 110, or moving both of the laser 150 and the label assembly 110.

Typical power levels for lasers in many digital converting lines are within a range of from 200 watts to about 1,000 watts, with one or two 400 watt laser(s) used in many applications. As will be appreciated by those skilled in the art, lasers are often pulsed at certain intervals or frequencies with certain pulse duration(s). With these two parameters, one can define a duty cycle or the percentage of time that the laser is radiating. The duty cycle equals frequency multiplied by the pulse duration. For example, a 60% duty cycle refers to the laser being on 60% of the time in a given period, and off 40% of the time. In many cutting applications, typical duty cycles are within a range of from 30% to 100%, with 50% to 80% being useful for many cutting applications.

In addition to the enhanced durability and laser cuttability of the subject films, are enhancements to ink adhesion and ink cure time on the disclosed films. The speed at which an ink will cure on a film substrate determines quality (faster is better) and determines press time. Restated, the faster an ink cures on a given substrate (e.g., label), the faster the press can run, thereby increasing efficiency and productivity of the printing asset. In many instances, a converter is required to balance ink adhesion performance with press speed, as there is a demonstrated inverse relationship between ink adhesion performance and press speed. As a means for avoiding the tradeoff between ink adhesion and press speed, inherently printable films (i.e., films without a coating, whether a topcoat or a print primer) have been developed. Alternatively, a print primer or a topcoat may be deposited on the surface of the labelstock to be printed. Naturally, deposition of a topcoat or primer increases ink adhesion performance, but addition of this material to the labelstock also increases the cost of the label construction. In view of ever increasing food contact regulations, industrial drive toward sustainability, and cost reasons, it is desirable to obtain enhanced ink adhesion performance without the additional cost and time attributable to top-coating a labelstock.

It is recognized in the art that a combination of resin formula and surface treatment can achieve a desired print/ink adhesion result, whether the treatment be corona, plasma, or flame treatment or flame plasma treatment. In one instance, the film may be flame or flame plasma treated from 1,800-2,500 btu/in using a ratio of fuel to oxygen between 40:60 and 60:40. As a technology, surface treatment results in an increase in dyne level of the surface of the labelstock, and a corresponding increase in ink adhesion is the result. However, what is unexpected and found through print testing is that the cure rate of the ink is increased. With this unexpected result, the benefit is that a printer converter can run faster and still obtain the same ink adhesion by application of the enhanced surface treatment. Such increase in curing rate results in an ability to run a printing asset at a higher rate, thereby increasing productivity and efficiency and in turn decreasing cost per unit area.

### EXAMPLES

The film samples listed in the examples were produced using a conventional multilayer cast film co-extrusion process. Each of four extruders (A, B, C, and D) supplied a melt formulation to a feedblock where the melts were combined to form a single molten stream consisting of four different layers. The feedblock was configured such that up to a seven (7) layer multilayer film with layer structure ABCDCBA could be produced. For monolayer films, four extruders were all fed with the same material. For a three (3) layer film, extruders A and B were fed with different material as extruders C and D. For a five (5) layer film, extruder A, extruder C, and extruder D were all fed with different material. Extruder B material was the same as extruder A. For each sample, the molten stream was cast onto a cat roll with a chrome finish to be solidified and then carried on by multiple rollers with web tension control. Film samples were laminated with Avery S-692N or S7000 adhesive and BG40 white paper liner for laser cutting evaluation.

A successful formulation must respond to three conditions: 1—Good laser cutting performance, 2—About the same mechanical performance as a PE film of the same thickness, 3—For clear films, a measured optical clarity and haze comparable to the PE.

In a series of evaluations, samples 1-13 were prepared to assess modified polyolefin films and laser cutting such films in accordance with the present subject matter. Tables 3 and 4 set forth below summarize the constructions, agent(s), and concentration of such agents for each of samples 2-13 as compared to a control sample 1. EVA-18 represents ethylene vinyl acetate copolymer with 18% VA and EVA-28 represents ethylene vinyl acetate copolymer with 28% VA. The samples 3 and 4 present two cases of three layer construction of PE with EVA. The films present cuttability with 10.6 um laser although the films are more cuttable when the amount of EVA is higher. The samples 5, 6 and 7 are good examples of the opaque laser cuttable PE based films. Good to excellent working windows were obtained with these inorganic additives. The sample 13 presents a three layer construction with PP and EVA that is as conformable as a PE film and gives high level of laser cuttability.

TABLE 3
Samples 1-13

| Sample | |
|---|---|
| Number | Samples |
| 1 | 100% PE cast base film |
| 2 | 35% HDPE + 9% LLDPE + 56% EVA (blend of PEs and EVA |
| | before extrusion) |
| 3 | PE/EVA/PE (80% HD + 20% LD) (Three layer film |
| | PE/EVA/PE with 10% VA) |
| 4 | PE/EVA/PE (80% HD + 20% LD) (Three layer film |
| | PE/EVA/PE with 12.6% VA) |
| 5 | PE + TiO2 coated mica (PE + inorganic additive) |
| 6 | PE + mica coated TiO2 (PE + inorganic additive) |
| 7 | PE + mica coated TiO2 (PE + inorganic additive) |
| 8 | 85% PE + 15% polybatch (PE + inorganic additive) |
| 9 | 70% PE + 30% polybatch (PE + inorganic additive) |
| 10 | 100% HPP cast base film |
| 11 | 85% HPP + 15% EVA (blend of HPP with EVA at 2.5% VA) |
| 12 | 55% HPP + 45% EVA (blend of HPP with EVA at 7.5% VA) |
| 13 | PP/EVA/PP (35% PP/30% EVA/35% PP) (three layer with EVA |
| | making 30% of thickness) |

TABLE 4
Properties of Samples 1-13

| | MD | | | HAZE | |
|---|---|---|---|---|---|
| | Youngs | | | GUARD | |
| Sample | Modulus | | | PLUS | Laser |
| Number | (psi) | IR Absorbant % | | CLARITY | Cut Quality |
| 1 | 56 | | None | 91% | Bad |
| 2 | 42 | 10% | Vinyl | 53% | Good operating |
| | | | Acetate | | window |
| 3 | 35 | 10% | Vinyl | 82% | Good operating |
| | | | Acetate | | window |
| 4 | 17 | 12.6% | Vinyl | 88% | Excellent |
| | | | Acetate | | operating |
| | | | | | window |
| 5 | 56 | 2% | TiO₂ coated | 54% | Good operating |
| | | | mica | (light | window |
| | | | beige) | | |
| 6 | 56 | 5% | TiO₂ coated | 14% | Excellent |
| | | | mica | (light | operating |
| | | | | beige) | window |
| 7 | 56 | 10% | TiO₂ coated | 0% | Excellent |
| | | | mica | (white) | operating |
| | | | | | window |
| 8 | 56 | 7.5% | Silica | 58% | Good operating |
| | | | | (hazy) | window |
| 9 | 56 | 15% | Silica | 18% | Good operating |
| | | | | (very | window |
| | | | | hazy) | |
| 10 | 147 | 0% | None | 94.5% | Bad |
| 11 | 109 | 2.5% | Vinyl | 85% | OK |
| | | | Acetate | | |
| 12 | 62 | 7.5% | Vinyl | 61% | Good operating |
| | | | Acetate | | window |
| 13 | 66 | 5% | Vinyl | 94% | Excellent |
| | | | Acetate | | operating |
| | | | | | window |

In another set of evaluations, samples 14-20 were prepared and subjected to laser cutting as described herein. Table 5 set forth below summarizes the constructions, agent(s), and concentration of such agents for each of samples 14-20.

TABLE 5
Samples 14-20

| | | | | | | | | | | | HAZE | |
|---|---|---|---|---|---|---|---|---|---|---|---|---|
| | | | Film | VA % in | CD | MD | CD 2% | MD 2% | CD | MD | GUARD | |
| | | | Thick- | The | Youngs | Youngs | Secant | Secant | Tensile | Tensile | PLUS | LASER |
| Sample | Film | Layer | ness | Entire | Modulus | Modulus | Modulus | Modulus | Strength | Strength | CLARITY | CUT |
| Number | Construction | Ratio | (mil) | Film | (Kpsi) | (Kpsi) | (Kpsi) | (Kpsi) | (Kpsi) | (Kpsi) | (%) | Quality |
| 14 | HDPE/EVA- | 28%/44%/ | 3.5 | 12.50% | 90.0 | 85.2 | 50.5 | 47.6 | 1.6 | 1.6 | 72.92 | No cut |
| | | 28% | | | | | | | | | | |
| 15 | 28/HDPE | 23%/54%/ | 3.5 | 15% | 92.5 | 88.1 | 50.8 | 49.5 | 1.5 | 1.6 | 76.9 | small |
| | | 23% | | | | | | | | | | operating |
| | | | | | | | | | | | | window |
| 16 | | 14%/72%/ | 3.5 | 20% | 66.5 | 68.5 | 37.6 | 39.1 | 1.2 | 1.3 | 78.5 | large |
| | | 14% | | | | | | | | | | operating |
| | | | | | | | | | | | | window |
| 17 | HDPE/EVA- | 18/27/10/ | 3.5 | 15% | 66.8 | 67.2 | 39.4 | 39.3 | 1.3 | 1.3 | 73.82 | medium |
| | 28/PP/EVA-28/ | 27/18 | | | | | | | | | | operating |
| | HDPE | | | | | | | | | | | window |
| 18 | | 13/27/20/ | 3.5 | 15% | 67.2 | 66.1 | 44.3 | 42.0 | 1.4 | 1.4 | 84.78 | larger |
| | | 27/13 | | | | | | | | | | operating |
| | | | | | | | | | | | | window |
| 19 | | 7/27/30/ | 3.5 | 15% | 47.8 | 50.0 | 30.1 | 33.9 | 1.1 | 1.2 | 89.22 | smaller |
| | | 27/7 | | | | | | | | | | operating |
| | | | | | | | | | | | | window |
| 20 | HDPE/EVA- | 10/30/20/ | 3.5 | 10.8% | 61.6 | 68.5 | 38.0 | 42.7 | 1.3 | 1.5 | 79.84 | large |
| | 18/PP/EVA-18/ | 30/10 | | | | | | | | | | operating |
| | HDPE | | | | | | | | | | | window |
| 21 | | 10/25/30/ | 3.5 | 9% | 109.3 | 109.5 | 70.3 | 68.5 | 2.2 | 2.2 | 81.3 | large |
| | | 25/10 | | | | | | | | | | operating |
| | | | | | | | | | | | | window |
| 22 | 100% HPP | | 3 | 0 | 182.6 | 174.3 | 123.8 | 115.9 | 3.3 | 3.2 | 80.66 | No cut |
| 23 | 85% HPP/15% | 100 | 2.5 | 2.70% | 142.1 | 144.5 | 95.1 | 101.0 | 2.7 | 2.9 | 62.8 | medium |
| | EVA_18 blend | | | | | | | | | | | operating |
| | | | | | | | | | | | | window |
| 24 | 55% HPP/45% | 100 | 2.5 | 8.10% | 101.1 | 106.1 | 71.5 | 71.8 | 2.2 | 2.2 | 53.24 | Very large |
| | EVA_18 blend | | | | | | | | | | | operating |
| | | | | | | | | | | | | window |

Table 5 summarizes two sets of trials. In certain trials, higher e-modulus films were formed by using HDPE instead of a blend of HDPE and LLDPE, and also by using a PP layer in the core of five (5) layer films. In other trials, new blends of HPP with EVA were formed. Most of the films of the first set based on PE (except samples 15 and 19) worked well with laser cutting and demonstrated good tensile modulus and film clarity. The second set did not result in high clarity but rendered cuttable the previously uncuttable clear films.

In another series of evaluations, investigation was made into developing a multilayer film that was laser cuttable and that behaved or exhibited properties similar to a polyethylene film commercially available from Avery Dennison under the designation PE85. Samples of multilayer films having constructions of PE/EVA/PP/EVA/PE were obtained and oriented in the machine direction. Table 6, set forth below summarizes these samples and presents their measured Youngs Modulus in CD and MD directions, CD and MD thickness, and tensile strengths in CD and MD directions. Optical measurements were then made using the noted HAZE GUARD instrument.

TABLE 6
Summary of Samples

| | | | | | | | | | | | | HAZE |
|---|---|---|---|---|---|---|---|---|---|---|---|---|
| | | | | | | | | | | HAZE | HAZE | GUARD |
| | | | Film | CD | MD | CD 2% | MD 2% | CD | MD | GUARD | GUARD | PLUS |
| | Film | | Thick- | Youngs | Youngs | Secant | Secant | Tensile | Tensile | PLUS | PLUS | TRANS- |
| Sample | Structure | | ness | Modulus | Modulus | Modulus | Modulus | Strength | Strength | CLARITY | HAZE | MISSION |
| Number | (5 Layers) | Layer Ratio | (μm) | (Kpsi) | (Kpsi) | (Kpsi) | (Kpsi) | (Kpsi) | (Kpsi) | (%) | (%) | (%) |
| 25 | HDPE/ | 10/25/30/25/10 | 2.6 | 69 | 153 | 65 | 145 | 2.0 | 17.7 | 78.7 | 10.8 | 92.2 |
| | EVA- | | | | | | | | | | | |
| 26 | 18/PP/ | 10/20/40/20/10 | 2.8 | 90 | 203 | 87 | 191 | 3.0 | 23.9 | 77.8 | 10.4 | 92.1 |
| | EVA- | | | | | | | | | | | |
| 27 | 18/HDPE | 10/30/20/30/10 | 2.8 | 50 | 117 | 48 | 111 | 1.4 | 13.3 | 81.1 | 10.5 | 92.3 |
| 28 | (MDO | 15/30/10/30/15 | 2.7 | 33 | 102 | 29 | 99 | 0.8 | 10.4 | 67.5 | 14.6 | 92.3 |
| 29 | Stretching | 15/20/30/20/15 | 2.8 | 88 | 196 | 84 | 182 | 2.8 | 21.3 | 81.8 | 7.3 | 92.2 |
| 30 | x5.6) | 5/25/40/25/5 | 2.6 | 76 | 175 | 74 | 166 | 2.3 | 21.7 | 69.6 | 15.1 | 92.3 |

In order to compare properties and measurements of the samples listed in Table 6 with currently available films, corresponding properties and measurements were obtained for commercially available films GLOBAL MDO, FASCLEAR 250, and PE85, all available from Avery Dennison.

The multilayer film samples according to an embodiment of the present subject matter exhibit comparable properties to the noted commercially available films. And in certain aspects, the film samples exhibit superior properties to the noted commercially available films.

In another series of evaluations, samples of multilayer films were obtained, evaluated, and compared to certain commercially available films.

Specifically, two cast films and two MDO films were obtained as listed in Table 7. CD and MD thickness values were measured and various physical properties were obtained as listed in Table 7.

TABLE 7
Summary of Samples

| | | | | | CD | MD | CD 2% | MD 2% | CD | |
|---|---|---|---|---|---|---|---|---|---|---|
| | | | | Film | Youngs | Youngs | Secant | Secant | Tensile | MD Tensile |
| Sample | | | | Thickness | Modulus | Modulus | Modulus | Modulus | Strength | Strength |
| Number | Formulation | Layer Ratio | MDO or CAST | (mil) | (Kpsi) | (Kpsi) | (Kpsi) | (Kpsi) | (Kpsi) | (Kpsi) |
| 31 | HDPE/EVA/HPP/ | 10/25/30/25/10 | MDO x5.6 | 2.1 | 113 | 202 | 106 | 187 | 3.7 | 20.9 |
| | EVA/HDPE | | | | | | | | | |
| 32 | HDPE/EVA/HDPE | 20/60/20 | CAST | 3.6 | 40 | 39 | 37 | 29 | 2.5 | 2.0 |
| 33 | HDPE/EVA/ | 10/25/30/25/10 | CAST | 3.5 | 59 | 64 | 55 | 58 | 3.9 | 4.3 |
| | (85% HPP + 15% | | | | | | | | | |
| | LLDPE)/EVA/HDPE | | | | | | | | | |
| 34 | HDPE/EVA/ | 10/25/30/25/10 | MDO X5.6 | 2.5 | 75 | 148 | 72 | 138 | 3.2 | 15.5 |
| | (85% HPP + 15% | | | | | | | | | |
| | LLDPE)/EVA/HDPE | | | | | | | | | |

Additional physical measurements were obtained for the samples of Table 7 including several optical characteristics. Table 8 summarizes this data.

TABLE 8
Properties and Measurements of Samples

| | L and W | L and W | | | | | |
|---|---|---|---|---|---|---|---|
| | Bending | Bending | 100° C. | 100° C. | | | |
| Sample | Resistance | Resistance | Shrink | Shrink | Clarity | | Transmission |
| Number | CD (mN) | MD (mN) | CD (%) | MD (%) | (%) | Haze (%) | (%) |
| 31 | 15.5 | 17.2 | 0.00 | 1.51 | 91.0 | 3.0 | 90.9 |
| 32 | 48.6 | 43.2 | 0.75 | 1.14 | 91.3 | 6.7 | 91.0 |
| 33 | 35.1 | 32.1 | 0.50 | 0.25 | 96.8 | 5.5 | 91.2 |
| 34 | 25.2 | 25.7 | 0.25 | 2.39 | 94.4 | 5.2 | 91.0 |

The physical properties and characteristics of the samples of Tables 7 and 8 can be compared to those of certain commercially available films as set forth in Table 9.

TABLE 9
Various Properties and Measurements of Commercially Available Films

| | | | | | | | | HAZE | HAZE | HAZE |
|---|---|---|---|---|---|---|---|---|---|---|
| | | CD 2% | MD 2% | CD | MD | L and W | L and W | GUARD | GUARD | GUARD |
| Comparison | Film | Secant | Secant | Tensile | Tensile | Bending | Bending | PLUS | PLUS | PLUS TRANS- |
| with G-MDO & | Thickness | Modulus | Modulus | Strength | Strength | Resistance | Resistance | CLARITY | HAZE | MISSION |
| F/P Films | (mil) | (Kpsi) | (Kpsi) | (Kpsi) | (Kpsi) | CD (mN) | MD (mN) | (%) | (%) | (%) |
| Global MDO | 2.0 | 70 | 200 | 3.3 | 28 | 10 | 15 | opaque | N/A | |
| white | | | | | | | | | | |
| Global MDO | 2.0 | 80 | 215 | 3.7 | 30 | 13 | 29 | 43 | 44 | |
| clear | | | | | | | | | | |
| Fasclear 250 | 2.5 | 79 | 141 | 2.4 | 19 | 16 | 31 | 39 | 60 | |
| Fasclear 300 | 3.0 | 60 | 120 | 3.3 | 19 | 21 | 39 | 37 | 60 | |
| Primax 250 | 2.5 | 71 | 136 | 2.3 | 17.2 | 17 | 35 | opaque | N/A | |
| Primax 300 | 3.0 | 67 | 140 | 2.5 | 19 | 22 | 45 | opaque | N/A | |
| PE 85 Clear | 3.4 | 96 | 71 | 2.7 | 2.9 | 47 | 35 | 91.5 | 23.3 | 91.4 |

As shown in Tables 7-9, the multilayer film samples according to an embodiment of the present subject matter exhibit comparable properties, and in certain regards superior properties, as compared to the noted commercially available films. Laser cutting and matrix stripping of roll forms of Sample Numbers 31, 33, and 34 in Table 8 laminated on paper liner were all successfully tested on industrial laser converting machines. In a separate trial, the applicability of the labels on containers was also successfully tested

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A method of laser cutting a polyolefin film using a CO₂ laser, the method comprising:
providing a polyolefin material;
incorporating at least one agent in the polyolefin material, the agent selected from the group consisting of at least one inorganic agent, at least one organic agent, and combinations thereof, to thereby form a modified polyolefin material having an increased optical absorbance;
forming a film from the modified polyolefin material;
using at least one CO₂ laser, laser cutting the film.

2. The method of claim 1 wherein the CO₂ laser emits light having a wavelength of 10.6 microns.

3. The method of claim 1 wherein the CO₂ laser emits light having a wavelength in a range of from 10.2 microns to 10.25 microns.

4. The method of claim 1 wherein the polyolefin material includes polyethylene.

5. The method of claim 1 wherein the agent includes at least one inorganic agent.

6. The method of claim 5 wherein the inorganic agent is selected from the group consisting of (i) silica particulates, (ii) mica particulates coated with titanium dioxide, and (iii) combinations thereof.

7. The method of claim 6 wherein the inorganic agent is silica particulates.

8. The method of claim 7 wherein the silica particulates are incorporated in the polyolefin material at a weight percentage within a range of from 7.5% to 15%.

9. The method of claim 6 wherein the inorganic agent is mica particulates coated with titanium dioxide.

10. The method of claim 9 wherein the mica particulates coated with titanium dioxide are incorporated in the polyolefin material at a weight percentage within a range of from 2% to 20%.

11. The method of claim 1 wherein the agent includes at least one organic agent.

12. The method of claim 11 wherein the organic agent is selected from the group consisting of (i) polymers containing at least one vinyl acetate group, (ii) polymers containing at least one vinyl alcohol group, (iii) polyethylene terephthalate glycol (PETG), (iv) acrylics, (v) nylon, and (vi) combinations thereof.

13. The method of claim 12 wherein the organic agent includes polymers containing at least one vinyl acetate group.

14. The method of claim 13 wherein the polymer is a copolymer of ethylene and vinyl acetate.

15. The method of claim 14 wherein the copolymer has a vinyl acetate content within a range of from 2.5% to 55%.

16. The method of claim 12 wherein the organic agent includes polymers containing at least one vinyl alcohol group.

17. The method of claim 16 wherein the amount of the polymer containing at least one vinyl alcohol group is within a range of 2.5% to 55%.

18. The method of claim 12 wherein the organic agent is PETG.

19. The method of claim 18 wherein the amount of the PETG is within a range of 2.5% to 55%.

20. The method of claim 12 wherein the organic agent is acrylic.

21. The method of claim 20 wherein the acrylic is PMMA.

22. The method of claim 21 wherein the amount of the PMMA is within a range of 2.5% to 55%.

23. The method of claim 12 wherein the organic agent is nylon.

24. The method of claim 23 wherein the amount of the nylon is within a range of from 2.5% to 55%.

25. The method of claim 23 wherein the nylon is amorphous nylon.

26. The method of claim 1 wherein the film is a multilayer film.

27. The method of claim 26 wherein the multilayer film includes a number of layers from two to five.

28. The method of claim 26, wherein the multilayer film includes five layers.

29. The method of claim 26 wherein the multilayer film includes a core layer having a layer thickness of from 5% to 75% based upon the total thickness of the multilayer film.

30. The method of claim 26 wherein the multilayer film includes a skin layer having a layer thickness of from 5% to 45% based upon the total thickness of the multilayer film.

31. The method of claim 26 wherein the multilayer film includes an intermediate layer having a layer thickness of from 2% to 15% based upon the total thickness of the multilayer film.

32. The method of claim 26 wherein the multilayer film includes a tie layer.

33. The method of claim 1 wherein the clarity of the modified polyolefin material is within 10% of the clarity of the polyolefin material free of the agent(s).

34. The method of claim 1 wherein the polyolefin film is included in a label assembly that also includes adhesive between the polyolefin film and a liner.

35. The method of claim 34 wherein the laser cutting of the film avoids damaging or cutting the liner.

36. The method of claim 1 wherein the film formed from the modified polyolefin material is kiss cut in a label assembly using a CO₂ laser.

37. The method of claim 36 wherein the CO₂ laser emits light having a wavelength of 10.6 microns.

38. The method of claim 36 wherein the CO₂ laser emits light having a wavelength in a range of from 10.2 microns to 10.25 microns.

39. The method of claim 1 wherein the forming of the film is performed by a method selected from the group consisting of casting, stentering, orienting and combinations thereof.

40. The method of claim 39 wherein the film is formed by orienting the film.

41. The method of claim 40 wherein the oriented film is stretched at a stretch ratio within a range of from 3:1 to 15:1.

42. The method of claim 41 wherein the film is stretched at a stretch ratio within a range of from 5:1 to 10:1.

43. The method of claim 1 wherein the film formed from the modified polyolefin material exhibits a clarity level of at least 80%.

44. The method of claim 43 wherein the film formed from the modified polyolefin material exhibits a clarity level of at least 90%.

45. The method of claim 1 wherein the film formed from the modified polyolefin material exhibits a Young's modulus within a range from 7 KPSI to 550 KPSI in a machine direction.

46. The method of claim 45 wherein the film formed from the modified polyolefin material exhibits a Young's modulus of at least 150 KPSI in the machine direction.

47. A multilayer film that can be cut using a CO₂ laser, the multilayer film comprising:
a core layer; and
at least one skin layer;
wherein at least one of the core layer and the at least one skin layer includes a polyolefin and at least one agent at a concentration such that the multilayer film exhibits an increased optical absorbance to light having a wavelength of 10.6 microns or within a range of from 10.2 microns to 10.25 microns.

48. The multilayer film of claim 47 wherein the multilayer film includes a number of layers from two to five.

49. The multilayer film of claim 48 wherein the multilayer film includes five layers.

50. The multilayer film of claim 47 wherein the core layer of the multilayer film has a layer thickness of from 5% to 75% based upon the total thickness of the multilayer film.

51. The multilayer film of claim 47 wherein the skin layer of the multilayer film has a layer thickness of from 5% to 45% based upon the total thickness of the multilayer film.

52. The multilayer film of claim 47 further comprising an intermediate layer, wherein the intermediate layer of the multilayer film has a layer thickness of from 2% to 15% based upon the total thickness of the multilayer film.

53. The multilayer film of claim 47 further comprising a tie layer.

54. The multilayer film of claim 47 wherein the polyolefin material is polyethylene.

55. The multilayer film of claim 47 wherein the agent includes at least one organic agent.

56. The multilayer film of claim 55 wherein the organic agent is selected from the group consisting of (i) polymers containing at least one vinyl acetate group, (ii) polymers containing at least one vinyl alcohol group, (iii) polyethylene terephthalate glycol (PETG), (iv) acrylics, (v) nylon, and (vi) combinations thereof.

57. The multilayer film of claim 56 wherein the organic agent includes polymers containing at least one vinyl acetate group.

58. The multilayer film of claim 57 wherein the polymer is a copolymer of ethylene and vinyl acetate.

59. The multilayer film of claim 58 wherein the copolymer has a vinyl acetate content within a range of from 2.5% to 55%.

60. The multilayer film of claim 56 wherein the organic agent includes polymers containing at least one vinyl alcohol group.

61. The multilayer film of claim 60 wherein the amount of the polymer containing at least one vinyl alcohol group is within a range of 2.5% to 55%.

62. The multilayer film of claim 56 wherein the organic agent is PETG.

63. The multilayer film of claim 62 wherein the amount of the PETG is within a range of 2.5% to 55%.

64. The multilayer film of claim 56 wherein the organic agent is acrylic.

65. The multilayer film of claim 64 wherein the acrylic is PMMA.

66. The multilayer film of claim 65 wherein the amount of the PMMA is within a range of 2.5% to 55%.

67. The multilayer film of claim 56 wherein the organic agent is nylon.

68. The multilayer film of claim 67 wherein the amount of the nylon is within a range of from 2.5% to 55%.

69. The multilayer film of claim 67 wherein the nylon is amorphous nylon.

70. The multilayer film of claim 47 wherein the clarity of the multilayer film is within 10% of the clarity of the multilayer film free of the agent(s).

71. The multilayer film of claim 47 wherein the multilayer film is included in a label assembly that also includes adhesive between the multilayer film and a liner.

72. The multilayer film of claim 71 wherein the label assembly can be laser kiss cut without damaging or cutting the liner.

73. The multilayer film of claim 72 wherein the laser kiss cut is performed using a CO₂ laser.

74. The multilayer film of claim 47 wherein at least one of the core layer and the skin layer that includes the polyolefin and the agent(s) is a film selected from the group consisting of a cast film, a stentered film, an oriented film, and a non-oriented film.

75. The multilayer film of claim 47 wherein the film is stretched at a stretch ratio within a range of from 3:1 to 15:1.

76. The multilayer film of claim 75 wherein the film is stretched at a stretch ratio within a range of from 5:1 to 10:1.

77. The multilayer film of claim 47 wherein the film exhibits a clarity level of at least 80%.

78. The multilayer film of claim 77 wherein the film exhibits a clarity level of at least 90%.

79. The multilayer film of claim 47 wherein the film exhibits a Young's modulus within a range from 7 KPSI to 550 KPSI in a machine direction.

80. The multilayer film of claim 79 wherein the film exhibits a Young's modulus of at least 150 KPSI in the machine direction.
